(19) United States
(12) Patent Application Publication
(10) Pub. No.: US 2017/0269931 A1
(43) Pub. Date: Sep. 21, 2017

(54) Method and Computing System for Handling Instruction Execution Using Affine Register File on Graphic Processing Unit

(71) Applicants: National Taiwan University, Taipei City (TW); MEDIATEK INC., Hsin-Chu (TW)

(72) Inventors: Yuan-Shin Hwang, New Taipei City (TW); Jenq-Kuen Lee, Hsinchu City (TW); Shao-Chung Wang, Taichung City (TW); Li-Chen Kan, Hsinchu County (TW)

(21) Appl. No.: 15/071,219

(22) Filed: Mar. 16, 2016

(51) Int. Cl. G06F 9/30

(52) U.S. Cl. CPC G06F 9/3001; G06F 9/30036; G06F 9/30072; G06F 9/30181; G06F 9/30145; G06F 9/30098

(57) ABSTRACT

The present invention provides an affine engine design to the microarchitecture of the graphic processing unit, in which an operand type detection is performed, and then physical scalar, affine, or vector registers and corresponding ALUs with maximum performance improving and energy saving are allocated to perform instruction execution. In runtime, affine and uniform instructions are executed by the affine engine, while general vector instructions are executed by a vector engine, thereby the affine/uniform instruction execution can be dispatched to the affine engine, so the vector engine can enter a power-saving state to save the energy consumption of the GPU.

### BACKGROUND OF THE INVENTION

1. Field of the Invention

The present invention relates to a method and computing system for handling instruction execution of a program for a graphic processing unit, and more particularly, to a method and computing system for handling uniform and affine instruction execution using affine engine register file on graphic processing unit.

2. Description of the Prior Art

Modern graphic processing units (GPUs) are designed as single instruction multiple data (SIMD) execution model that groups the parallel threads to execute the single instruction in lock-step. According to observation, many SIMD groups in the GPU execute with the same input value and generate the same output value, which leads to redundant computations and memory accesses when using all registers and all arithmetic logic units (ALUs) in SIMD lanes, where multiple data are simultaneously computed by multiple SIMD lanes and each data takes one SIMD lane.

To eliminate redundant computations and memory accesses, a uniform register file (RF) is proposed for scalar instruction execution, where the work of the GPU is dedicated to optimize instruction execution for uniform vectors (e.g., scalars) by using part of registers and one ALU in one SIMD lane, or performing scalar instruction execution on a specific scalar register and ALU. However, the value with affine type (e.g., the value of an affine vector) is not handled by the uniform RF.

Moreover, a scalar processor is also proposed to handle uniform instruction execution. If a scheduler of the GPU finds that the following instructions waiting for processing are uniform instructions, the work will be dispatched to the scalar processor. Otherwise, the work will be dispatched to a vector processor of the GPU. However, the scalar processor cannot handle the value with affine type. Despite that the vector processor can handle the value with affine type, it brings redundant computations and memory accesses when using all registers and all ALUs in one SIMD lane to handle the value with affine type.

To separately handle the value with affine type, an affine cache and dedicated hardware for affine value detection are proposed to handle the affine vector, but they use a complicated hardware design to be impractical in implementation.

With the increasing number of threads and registers, how to eliminate redundant computations and memory accesses for affine instruction execution to reduce energy consumption has become a crucial issue.

### SUMMARY OF THE INVENTION

It is therefore an objective of the present invention to provide a method and computing system for handling instruction execution of a program for a graphic processing unit.

The present invention provides an affine engine design to the microarchitecture of the graphic processing unit, in which an operand type detection is performed to add annotations on each instruction and corresponding operands, and then physical scalar, affine, or vector registers and corresponding ALUs with maximum performance improving and energy saving are allocated to perform the instruction execution. In runtime, affine and uniform instructions are executed by the affine engine including a scalar register file (RF), an affine RF and at least on scalar arithmetic logic units (ALUs) in one SIMT core, while general vector instructions are executed by a vector engine including a vector RF and a plurality of vector ALUs in one SIMT core. Therefore, the affine and uniform instruction execution can be dispatched to the affine engine, so the vector engine can enter a power-saving state to save the energy consumption of the GPU.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates data patterns of uniform vectors corresponding to uniform registers.

FIG. 2 illustrates data patterns of affine vectors corresponding to affine registers.

FIG. 3 illustrates microarchitecture of a GPU according to an embodiment of the present invention.

FIG. 4 to FIG. 9 illustrates instruction execution and ALU allocations of the GPU in FIG. 3 corresponding to different instruction types and operand (or register/value) types according to various embodiments of the present invention.

FIG. 10 is a flowchart of a process according to an embodiment of the present invention.

FIG. 11 illustrates an exemplary program dependence graph of the kernel sample code in Table 3.

FIG. 12 illustrates an exemplary program dependence graph of the kernel sample code in Table 4.

FIG. 13 illustrates updated program dependence graph which is generic from FIG. 12.

### DETAILED DESCRIPTION

The present invention utilizes an affine engine including a scalar register file (RF), an affine RF and two scalar arithmetic logic units (ALUs) in one SIMT core to manage affine instruction execution as well as uniform instruction execution. A graphic processing unit (GPU), instructed by a compiler, first performs operand type detection to add annotations on each instruction and corresponding operands, and then allocates physical scalar, affine, or vector registers and corresponding ALUs with maximum performance improving and energy saving. In runtime, affine and uniform instructions are executed by the affine engine, and general vector instructions are executed by a vector engine including a vector RF and a plurality of vector ALUs in one SIMT core. Therefore, the affine/uniform instruction executions can be dispatched to the affine engine, so the vector engine can enter a power-saving state to save the energy consumption of the GPU.

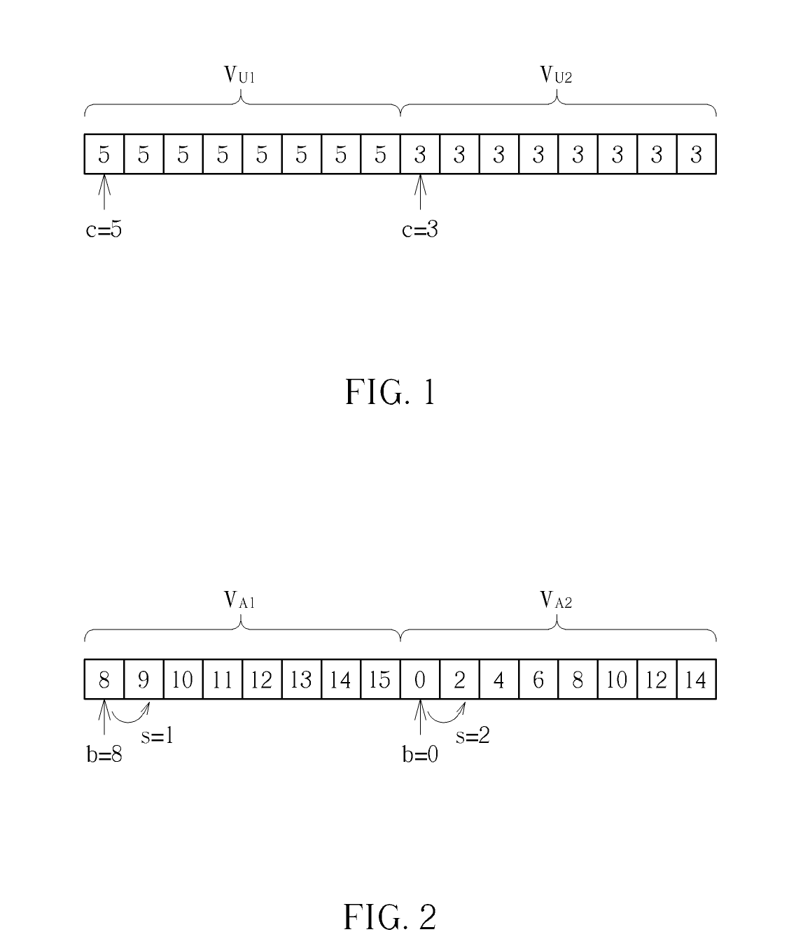

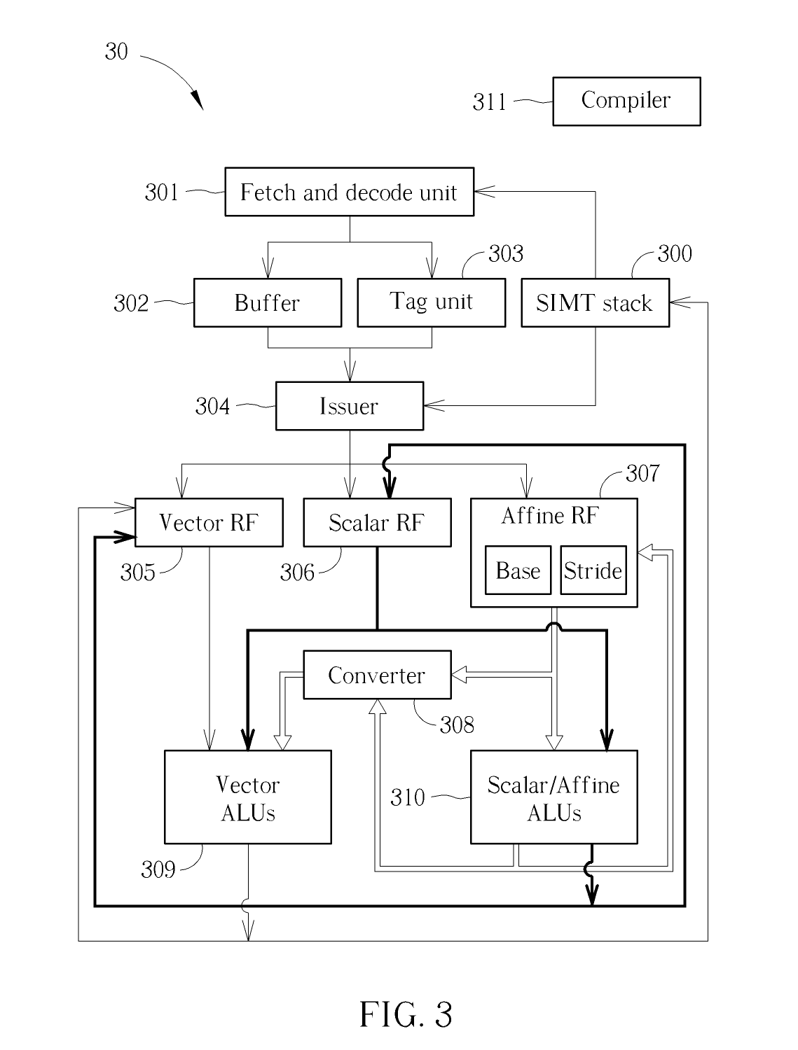

FIG. 1 illustrates exemplary data patterns of uniform vectors corresponding to uniform registers. FIG. 2 illustrates exemplary data patterns of affine vectors corresponding to affine registers.

In FIG. 1, a uniform vector is represented as V_{U}[i]=c, where “i” is an array index corresponding to distinct thread identifiers (IDs), and “c” is a scalar value of the uniform vector. The values of the uniform vector for every thread are the same scalar “c”, so it does not depend on the thread identifiers “i”. For example, assume that a uniform vector is represented as V_{U1} [i]=5, and another uniform vector is represented as V_{U2} [i]=3. The values corresponding to all thread identifiers of the uniform vector V_{U1} are the same value “5”, and the values corresponding to all thread identifiers of the uniform vector V_{U2} are the same value “3”.

In FIG. 2, an affine vector is defined as V_{A}[i]=b+i*s, where “i” is an array index corresponding to distinct thread IDs (e.g., the thread IDs are assumed to be integers from 0 to 7 for an 8-bit affine vector), “b” is a scalar value named “base”, and “s” is another scalar value named “stride”. The values of the affine vector depend on the thread IDs according to its definition. For example, assume that an affine vector is represented as V_{A1}[i]=8+i*1, and another affine vector is represented as V_{A2} [i]=0+i*2. The values corresponding to the thread IDs of the affine vector V_{A1} are integers “8, 9, 10, 11, 12, 13, 14 and 15”, respectively. The values corresponding to the thread IDs “0, 1, 2, 3, 4, 5, 6 and 7” of the affine vector V_{A2} are integers “0, 2, 4, 6, 8, 10, 12 and 14”, respectively.

Note that the uniform vector can be regarded as a special case of the affine vector having the stride with value “0”. In other words, the uniform vector is equivalent to Vᵤ=V_{A}[i]=b+i*0 if the stride with value “0”. Therefore, the works associated with uniform vectors and instructions can be dispatched to the affine engine of the GPU.

To dispatch works to the affine engine, the instruction type must be determined in advance. An instruction declares operands (such as register variables, constant expressions, address expressions, or label names) and operators into machine languages, which can be translated by the compiler of the GPU, to instruct the GPU to perform certain instruction execution, so as to produce a result corresponding to the declared instruction. The instruction type is determined according to the type of the result after the instruction execution. Table 1 shows exemplary instructions and their types, where the exemplary instructions comply with Compute Unified Device Architecture (CUDA) defined by NVIDIA™ for General-purpose computing on graphics processing units (GPGPU) for example, which is not limited.

TABLE 1

| | Instruction | Propagation | Type |
|---|---|---|---|
| 1 | mov.u32 %u0, %ctaid.x; | U ← U | Uniform |
| 2 | mov.u32 %a0, %tid.x; | A ← U | Affine |
| 3 | mad.lo.s32 %a0, %u1, %u0, %a0; | A ← U + U*A | Affine |
| 4 | add.s32 %a3, %u2, %a0; | A ← A + A | Affine |
| 5 | ld.param.u32 %u1, [param3]; | U ← [U] | Uniform |
| 6 | ld.global.s32 %v2, [%a3]; | V ← [A] | Vector |

Regarding the first instruction “mov.u32 %u0, %ctaid.x”, “mov” is an operator (instruction keyword) for moving value(s) of source register(s) to target register(s), and “mov.u32” specifies that the operator “mov” moves an unsigned integer with size 32 bits. “%u0” and “%ctaid.x” are uniform registers for uniform operands, where “%u0” is a destination register, and “%ctaid.x” is a source register and a component register of a vector register “%ctaid”. Accordingly, the first instruction can be interpreted as: moving the value of the uniform source register “%ctaid.x” to the uniform destination register “%u0”. The result of the first instruction should be with the uniform type since the operator “mov” keeps the value of the registers “%u0” and “%ctaid.x” to be with uniform type. Therefore, the first instruction is a uniform instruction.

Further, to handle the uniform instruction “mov.u32 %u0, %ctaid.x”, allocating only one scalar ALU is enough for moving the scalar value of the source uniform register “%ctaid.x” to the destination uniform register “%u0” in one SIMT core. Therefore, if a uniform instruction is detected, the compiler allocates one scalar ALU with maximum performance improving and energy saving.

Regarding the second instruction “mov.u32 %a0, %tid.x”, “%a0” is an affine register for an affine operand, and “%tid.x” is a uniform register. “%ctaid” and “%tid” are predefined, read-only special registers initialized with a cooperative thread array (CTA) identifier and a thread identifier within a CTA, and contain a 1-dimentional (1D), 2-dimentional (2D), or 3-dimentional (3D) vector space. Accordingly, the second instruction can be interpreted as: moving the value of the uniform source register “%tid.x” to the affine destination register “%a0”. The result of the second instruction should be with the affine type since the operator “mov” moves the value of the register “%tid.x” to the affine register “%a0” with the affine type. Therefore, the second instruction is an affine instruction.

Further, to handle the affine instruction “mov.u32 %a0, %tid.x”, allocating only two scalar ALUs is enough for moving the scalar value of the source uniform register “%tid.x” to the destination affine register “%a0” in one SIMT core. The uniform vector is equivalent to the affine vector having the stride with value “0”, so the complier allocates two scalar ALUs to move the base value of the uniform register “%tid.x” and the stride value “0” (which is automatically generated by the compiler) to the affine register “%a0”. Therefore, if an affine instruction is detected, the compiler allocates two scalar ALUs with maximum performance improving and energy saving.

Regarding the third instruction “mad.lo.s32 %a0, %u1, %u0, %a0”, “mad” is an operator for multiplying two values to produce an intermediate result, optionally extracting the high or low half of the intermediate result, and then adding a third value to the intermediate result to produce a final result, and store the final result in the destination register. “mad.lo.s32” specifies extracting the low half of the intermediate result which is a signed integer with size 32 bits. Accordingly, the third instruction can be interpreted as: multiplying the values of the affine register “%a0” and the uniform register “%u0”, extracting the low half of the intermediate result, adding the value of the uniform register “%u1”, and finally writing back the result in the affine register “%a0”. The result of the third instruction should be with the affine type since the operator “mad” multiplies the uniform vector with the affine vector to generate the result to be the affine type. Therefore, the third instruction is an affine instruction.

Regarding the fourth instruction “add.s32 %a3, %u2, %a0”, “add” is an operator for adding two values. The fourth instruction can be interpreted as: adding the values of the affine register “%a0” and the uniform register “%u2”, and then writing back the result in the affine register “%a3”. The result of the fourth instruction should be with the affine type since the operator “add” adds the uniform vector and the affine vector together to generate the result to be the affine type. Therefore, the fourth instruction is an affine instruction.

Regarding the fifth instruction “ld.param.u32 %u1, [param3]”, “ld.param [ ]” is an operator for passing values from the host to the GPU. “param3” is a uniform parameter. The fifth instruction can be interpreted as: passing the value of the uniform parameter “param3” to the uniform register “%u1”. The result of the fifth instruction should be with the uniform type since the operator “ld.param” keeps the value of the uniform register “%u1” with the uniform type. Therefore, the fifth instruction is a uniform instruction.

Regarding the sixth instruction “ld.global.s32 %v2, [%a3]”, “ld.global [ ]” is an operator for accessing global variables. The sixth instruction can be interpreted as: accessing the value of the affine register “%a3” to the vector register “%v2”. The result of the sixth instruction should be with the vector type since the operator “ld.global [ ]” converts the value of the affine register “%a3” into the vector type. Therefore, the sixth instruction is a vector instruction.

In summary of analysis to the instructions listed in Table 1, the instruction type can be analyzed according to characteristics of the operations and the operand/register types declared in the instruction. The compiler can allocate one scalar ALU for scalar instruction execution or two scalar ALUs for affine instruction execution with maximum performance improving and energy saving. Table 2 shows a part of inferring rules to detect the instruction type, there may be special cases suitable for other inferring rules, which is not limited.

TABLE 2

| | Operand/Register | | Instruction |
|---|---|---|---|
| Rule | type | Operator | type |
| 1 | Uniform, Uniform | Add/Multiply/Shift | Uniform |
| 2 | Uniform, Affine | Add | Affine |
| 3 | Uniform, Affine | Multiply/Shift | Vector |
| 4 | Uniform, Vector | Add/Multiply/Shift | Vector |
| 5 | Affine, Affine | Add/Multiply/Shift | Vector |
| 6 | Affine, Vector | Add/Multiply/Shift | Vector |
| 7 | Vector, Vector | Add/Multiply/Shift | Vector |

Source: Sylvain Collange, David Defour and Yao Zhang, “Dynamic detection of uniform and affine vectors in GPGPU computations.”, Eruo-Par 2009

Note that all operands/registers including source and destination operands/registers declared in one instruction have a known type from their declarations. Each operand/register type must be compatible with the type determined by the instruction template and instruction type. Therefore, in one embodiment, the instruction type can be determined according to the type of the destination operand/register.

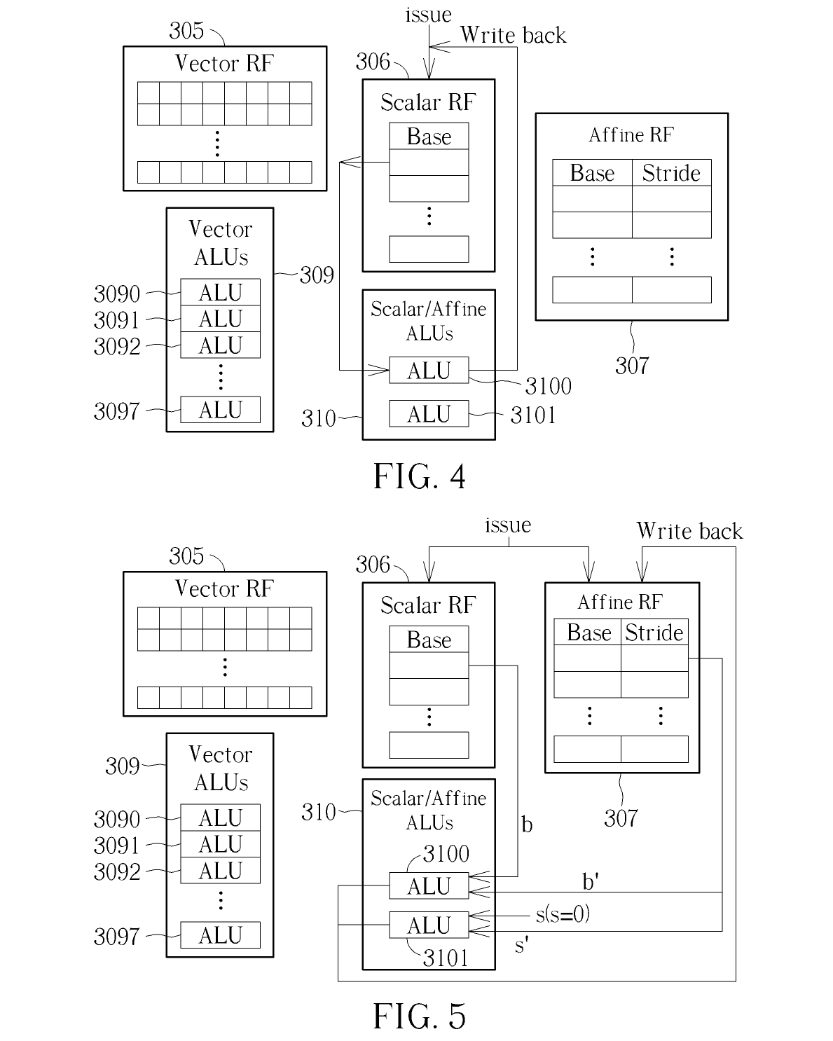

FIG. 3 illustrates microarchitecture of a GPU 30 according to an embodiment of the present invention. The GPU 30 or a computing system includes a SIMT (single instruction multiple thread) stack unit 300, a fetch and decode unit 301, a buffer 302, a tag unit 303, an issuer 304, a vector register file (RF) 305, a scalar RF 306, an affine RF 307, a converter 308, a group of vector arithmetic logic units (ALUs) 309, a group of scalar/affine ALUs 310, and a compiler 311. The hardware architecture of the GPU 30 is shown in FIG. 3, where data flow of uniform vectors is denoted with thick arrows and lines, and data flow of affine vectors is denoted with hollow arrows and lines.

The scalar RF 306, the affine RF 307 and the scalar/affine ALUs 310 cooperatively work as an affine engine for handling affine and uniform instruction execution. The vector RF 305 and the vector ALUs 309 cooperatively work as a vector engine for handling general vector instruction execution. Therefore, when the affine and uniform instruction execution is dispatched to the affine engine, the vector engine can enter a power-saving state to save the energy consumption of the GPU 30.

The compiler 311 is a computer program (or a set of programs) that transforms source code written in a programming language (the source language) into another computer language (the target machine language), and thereby controls operations of the GPU 30.

Affine and uniform vector detection can be handled either by the compiler 311 (software detection) or the fetch and decode unit 301 (hardware detection). In the case of software detection, the compiler 311 builds a program dependence graph (PDG) of the source program according to data dependence and control dependence of the source program, wherein the data dependence and the control dependence are derived from kernel function(s) built in programming framework or platform of the GPU 30.

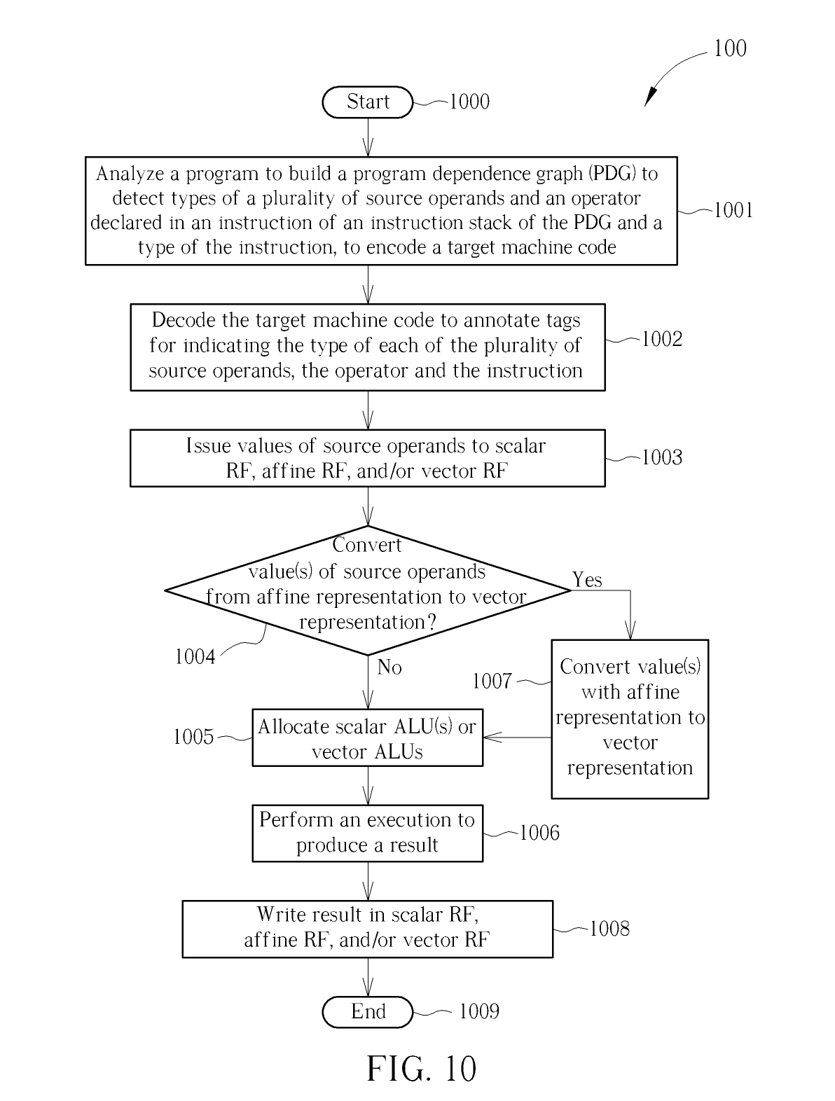

For example, Table 3 is a kernel sample code for CUDA™ programming framework. FIG. 11 illustrates an exemplary program dependence graph of the kernel sample code in Table 3, which is not limited. In FIG. 11, data dependence is denoted with thin arrows and lines, and control dependence is denoted with thick arrows and lines. Nodes with affine, uniform and vector types are denoted with triangle, square and circle shapes, respectively.

TABLE 3
CUDA ™ kernel sample code

S31: _{——}global_{——} void VecAdd( float* A, float* B, float*C, int N){

| | |
|---|---|
| S32: | int i = blockDim.x*blockIdx.x+threadIdx.x; |
| S33: | if (i<N) |
| S34: | C[i]=A[i]+B[i]; |

S35: }

In statement S32, the value of the operand “i” is computed according to the values of the operands “blockDim.x”, “blockIdx.x” and “threadIdx.x”, so data dependences are directed from the operands “blockDim.x”, “blockIdx.x” and “threadIdx.x” toward the operand “i”. CUDA™ programming framework defines a grid organized for a kernel, where a grid includes multiple blocks with certain block dimensions indicated by the operand “blockDim.x” (e.g., 1-dimentional or 2-dimentional) and block identifiers indicated by the operand “blockIdx.x” which can be 1-dimentional, or 2-dimentional, or 3-dimentional. The values of the operand “blockDim.x” and “blockIdx.x” are uniform for the same grid, so they are initialized to be nodes with uniform type. The operand “threadIdx.x” indicates thread identifiers of threads included in a block, so it is initialized to be the node with affine type.

In statements S31 and S33, the result of the condition “i<N” depends on the value of the operand “N”, so a data dependence is directed from the operand “N” toward the condition “i<N”. The operand “N” is initialized to be node with uniform type according to declared language (i.e., integer), and the condition “i<N” is initialized to be node with vector type with highest compatibility with other types because the type of the condition “i<N” is undetermined according to declared language.

In statement S34, the operands for arrays “C[i]”, “A[i]” and “B[i]” are initialized to be nodes with vector type with highest compatibility with other types because the type of the arrays “C[i]”, “A[i]” and “B[i]” is undetermined according to declared language. The result of the array “C[i]” is computed according to the values of the arrays “A[i]” and “B[i]”, so data dependences are directed from the arrays “A[i]” and “B[i]” toward the array “C[i]”. In statements S33 and S34, the condition “i<N” controls computation of statement 34, so control dependences are directed from the condition “i<N” toward the arrays “A[i]” and “B[i]”.

Once the program dependence graph is initially build and the node type initialization is done, the compiler 311 propagates the source program to the inferring rules listed in Table 2 (and other possible inferring rules) to update node type if necessary, and iteratively propagates the source program and updates node type until no types of the nodes are changed, so as to generate a finalized program dependence graph. Therefore, the compiler 311 can find the affine and uniform vectors according to the node type annotated in the finalized program dependence graph, and then encodes the source code into the target machine language based on the finalized program dependence graph.

In short, the compiler 311 finds the affine and uniform vectors by four steps: 1^{st}, build an initial program dependence graph; 2^{nd}, initialize node type on the initial program dependence graph; 3^{rd}, inferring propagation and update not type; and 4^{th}, repeat 3^{rd} step until no types of the nodes are changed.

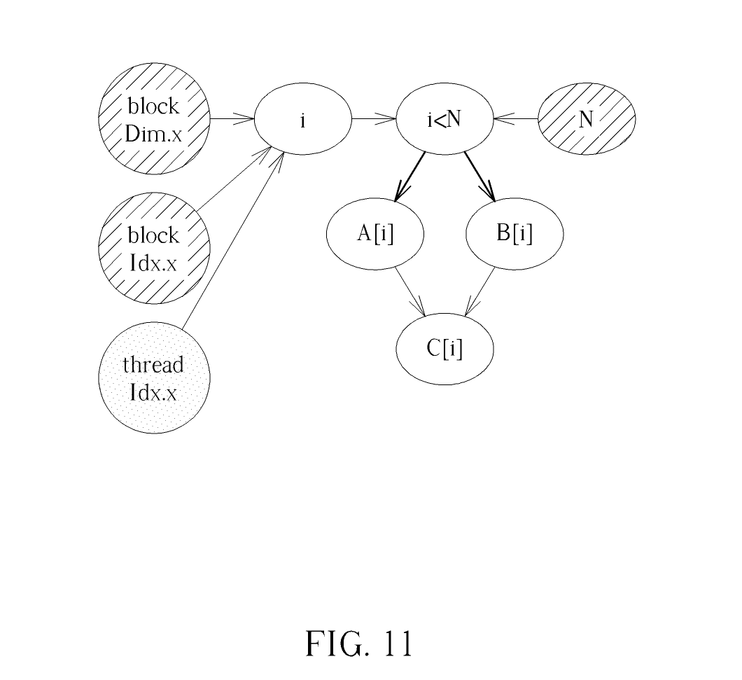

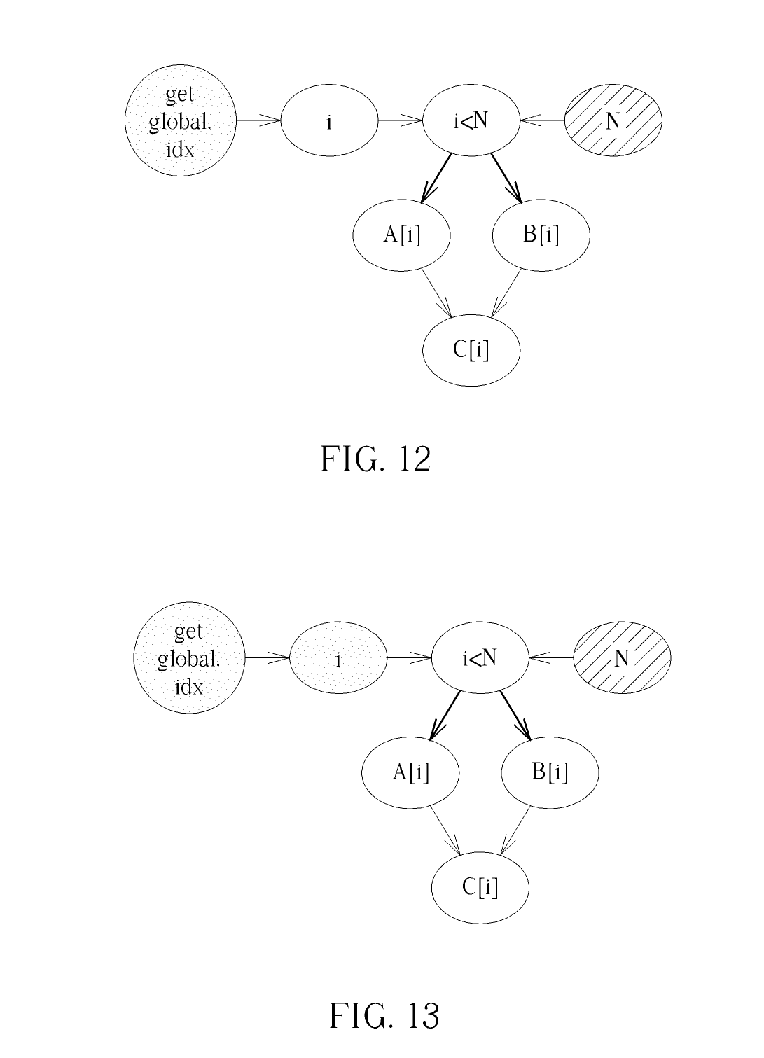

For another example, Table 4 is a kernel sample code for OpenCL™ programming framework, where OpenCL™ is another programming framework for heterogeneous computing devices that runs on CPUs, digital signal processing (DSP), GPUs or hardware accelerator. FIG. 12 illustrates an exemplary program dependence graph of the kernel sample code in Table 4, which is not limited. FIG. 13 illustrates an updated program dependence graph which is generic from FIG. 12. In FIG. 12 and FIG. 13, data dependence is denoted with thin arrows and lines, and control dependence is denoted with thick arrows and lines.

TABLE 4
OpenCL ™ kernel sample code

| S41: _{——}kernel void VecAdd(float* A, float* B, float*C, int N) { | |
|---|---|
| S42: | int i = get_global_id(0); |
| S43: | if (i<N) |
| S44: | C[i]=A[i]+B[i]; |

S45: }

OpenCL™ and CUDA™ kernel sample code are similar, a difference lies in statement S42 in which the operand “i” is derived from a function “get_global_id(0)” that returns global identifiers. The value of the operand “i” is derived from the function “get_global_id (0)”, so a data dependence is directed from the function “get_global_id(0)” toward the operand “i”. The operand “N” is initialized to be node with uniform type according to declared language. The function “get_global_id(0)” is initialized to be node with affine type, and the operand “i” and the operands for arrays “C[i]”, “A[i]” and “B[i]” are initialized to be nodes with vector type with highest compatibility with other types because the type of the arrays “C[i]”, “A[i]” and “B[i]” and the operand “i” is undetermined according to declared language. Rest of data dependences and control dependences of FIG. 12 and Table 4 can be obtained by referring to descriptions of FIG. 11 and Table 3.

In FIG. 13, during propagation, the compiler 311 updates the type of the node “i” from vector type to affine type because the values of the node “i” are thread identifiers returned by the function “get_global_id(0)”.

Once the finalized program dependence graph is built, the compiler 311 can find the affine and uniform vectors according to the node type annotated in the finalized program dependence graph, and then encodes the source code into the target machine code based on the finalized program dependence graph.

The fetch and decode unit 301 receives the target machine code from the compiler 311 to perform decoding. After decoding, the buffer 302 holds the instructions waiting to be executed, and the corresponding tags are saved in the tag unit 303. The issuer 304 issues the values of the instruction with vector, scalar, or affine type to the vector RF 305, the scalar RF 306 and the affine RF 307, respectively. The converter 308 converts the values of the instruction with affine representation into vector representation according to the type of the operator and the instruction type based on the inferring rules listed in Table 2, where the need of conversion is detected by the compiler 311 during software detection. Then, at least one scalar ALU of the scalar/affine ALUs 310 or the vector ALUs 309 is allocated for the instruction execution with respect to the operator and the values of the source operands/registers according to the tags for indicating the type of the source operands/registers and the operator, to produce a result with the same type as the instruction.

In other words, for the case of software detection, the compiler 311 detects the types of the instructions, operands/registers, and the need of conversion, and encodes these data into the target machine code, thereby the following hardware units (i.e., the fetch and decode unit 301, the buffer 302, the tag unit 303, the issuer 304, the register files 305, 306 and 307, the converter 308 and the ALUS 309 and 310) perform instruction execution according to the data decoded from the target machine code.

In the case of hardware detection, since the target machine code encoded by the compiler 311 does not include the types of the instructions, operands/registers, and the need of conversion, the fetch and decode unit 301 detects the types of the instructions and operands/registers according to the inferring rules listed in Table 2 and the detected types of the instructions and operands/registers are stored in the tag unit 303, the issuer 304 detects the need of conversion and the converter 308 performs the need of conversion. Operations of the buffer 302, the tag unit 303, the converter 308, the register files 305, 306 and 307, and the ALUS 309 and 310 are the same as the case of software detection.

When the vector instruction is issued, the vector RF 305 stores the values of the vector instruction to be accessed by the vector ALUs 309, the vector ALUs 309 performs the operations declared in the vector instructions to produce the results with vector type, and the results are written back to the vector RF 305 after the instruction execution.

When the uniform instruction is issued, the scalar RF 306 stores the scalar value of the uniform instructions to be accessed by the scalar/affine ALUs 310, the scalar/affine ALUs 310 performs the operations declared in the uniform instructions to produce the results with scalar type, and the results are written back to the scalar RF 306 after the instruction execution.

Note that the uniform vector can be regarded as a special case of an affine vector having the stride with value “0”. In other words, the uniform vector is equivalent to Vᵤ=V_{A}[i]=b+i*0 if the stride with value “0”. Therefore, the affine engine utilizes one ALU of the scalar/affine ALUs 310 to perform scalar instruction execution to achieve energy saving as well as memory access reduction.

When the affine instruction is issued, the affine RF 307 stores the values of the affine instruction to be accessed by the scalar/affine ALUs 310, the scalar/affine ALUs 310 performs the operations declared in the affine instructions to produce the result with affine type, and the result is written back to the affine RF 307 after the instruction execution.

Note that in Table 2, the fifth inferring rule specifies that: the combination of two affine vectors with add/multiply/shift operation produces the result with vector type, and the sixth inferring rule specifies that: the combination of one affine vector, one general vector and add/multiply/shift operation produces the result with vector type.

The overhead occurs from converting the value with affine representation into generic vector representation. These representation conversions can be auto-detected and performed by hardware (e.g. the converter 308) or adding a convert instruction by the compiler 311 to achieve software conversion. In one embodiment, a register with most benefit for placing the values with affine/uniform representation is allocated first.

Accordingly, the converter 308 translates or flattens the value with affine representation into vector representation for vector instruction execution to produce the result with general vector type (see the data flow of affine vectors in FIG. 3). Detailed operations of the converter 308 will be described in FIG. 9 and related descriptions.

Regarding the second, third and fourth inferring rules in Table 2, the scalar value of the uniform vector can be broadcasted to the vector ALUs 309 or the scalar/affine ALUs 310 (see the data flow of uniform vectors in FIG. 3) without representation translation.

Note that the load/store of global and local memory for uniform or affine vector has a benefit in the microarchitecture of the GPU 30. The uniform/affine value can be loaded just once from the memory corresponding to the uniform/affine register (i.e., the scalar RF 306 and the affine RF 307), and the values are compacted as simple descriptor for writing back to the memory to reduce memory traffic.

In short, the affine engine can handle the uniform and affine instruction execution based on the detection results via the software or hardware detection. Therefore, when the affine engine is working, the vector engine can enter the power-saving state to save the energy consumption of the GPU 30, and the utilization rate for registers and ALUs can be reduced since the affine engine utilizes at most two scalar ALUs.

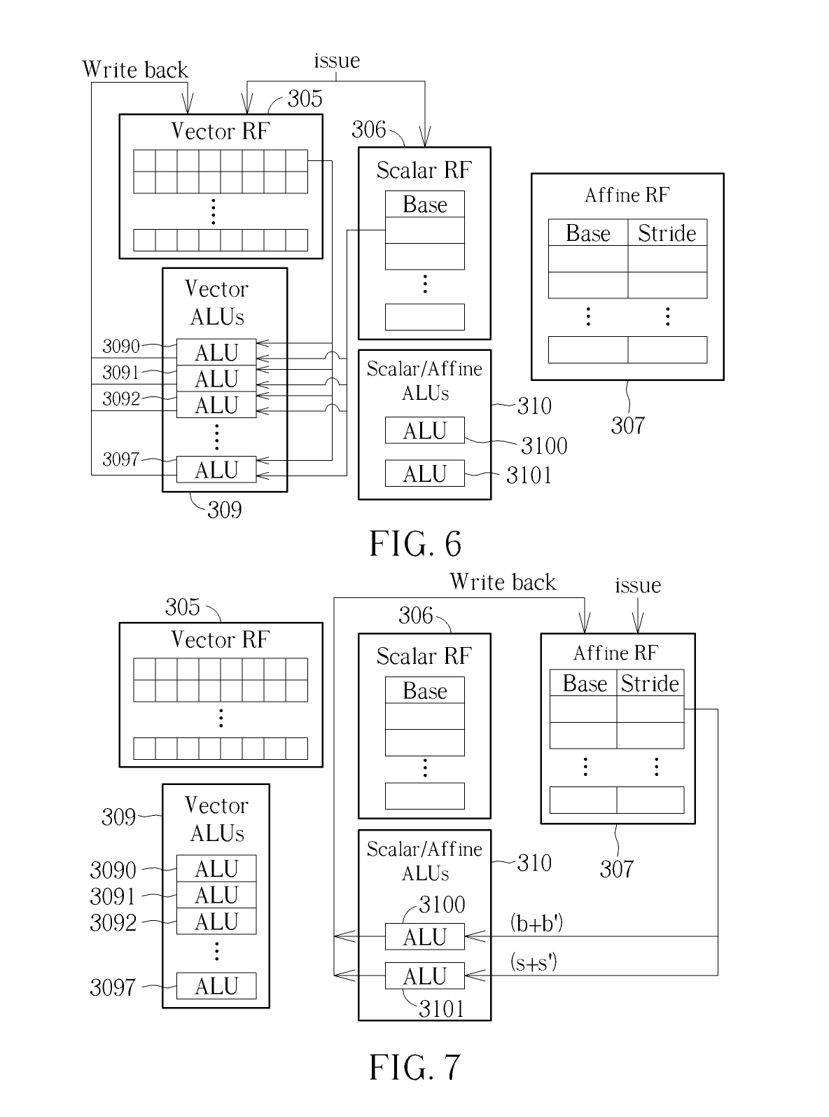

FIG. 4 to FIG. 9 illustrate instruction execution and ALU allocations of the GPU 30 corresponding to different instruction types and operand (or register/value) types according to various embodiments of the present invention. The vector ALUs 309 includes vector ALUs 3090-3097, and the scalar/affine ALUs 310 includes scalar ALUs 3100 and 3101.

In FIG. 4, if a uniform instruction for adding the values of two uniform operands/registers (i.e., the first inferring rule of Table 2) is inputted, the values of the two uniform operands are issued to the scalar RF 306 for access, and then the scalar ALU 3100 is allocated to perform add operation to produce a result with uniform type. Afterwards, the result with uniform type is written back to the scalar RF 306.

In FIG. 5, if an affine instruction for adding the values of one uniform operand/register and one affine operand/register (i.e. the second inferring rule of Table 2) is inputted, the values of the uniform and affine operands are respectively issued to the scalar RF 306 and affine RF 307 for access, and then the scalar ALUs 3100 and 3101 are allocated to perform add operation to produce a result with affine type. Afterwards, the result with affine type is written back to the affine RF 307.

For example, for adding one uniform vector V_{U}=b and an affine vector V_{A2}=b′+i*s′ together, a result A can be represented as:

A=Vᵤ+V_{A2}=(b+i*0)+(b′+i*s′)=(b+b′)+(0+s′)*i

Where the uniform vector V_{U}=b is a special case of an affine vector V_{A1}=b+i*s (where s=0, which is automatically generated by the compiler 311). Therefore, the scalar ALU 3100 can be used to perform add operation to the base scalars “b” and “b′”, and the scalar ALU 3101 can be used to perform add operation to the stride scalars “0” and “s′”.

In FIG. 6, if a vector instruction for adding the values of one uniform operand/register and one vector operand/register (i.e. the fourth inferring rule of Table 2) is inputted, the values of the uniform and vector operands/registers are respectively issued to the uniform RF 306 and the vector RF 305 for access, and then the vector ALUs 3090-3097 are allocated to perform add operation to produce a result with vector type, where the value of the uniform operand/register is broadcasted to each of the vector ALUs 3090-3097 from the uniform RF 306. Afterwards, the result with vector type is written back to the vector RF 305.

In FIG. 7, if an affine instruction for adding the values of two affine operands sharing the same thread ID access path (this is a special case of the fifth inferring rule of Table 2) is detected, the values of the two affine operands are issued to the affine RF 307 for access, and then the scalar ALUs 3100 and 3101 are allocated to perform add operation to produce a result with affine type. Afterwards, the result with affine type is written back to the affine RF 307.

For example, for adding one affine vector V_{A1}=b+i*s and another affine vector V_{A2}=b′+i*s′ together, a result A can be represented as:

A=V_{A1}+V_{A2}=(b+i*s)+(b′+i*s′)=(b+b′)+(s+s′)*i

As can be seen, allocating two scalar ALUs are enough to handle the affine instruction, where the scalar ALU 3100 can be used to perform add operation to the scalars “b” and “b′”, and the scalar ALU 3101 can be used to perform add operation to the scalars “s” and “s′”.

On the other hand, if an affine instruction for adding the values of two affine operands/registers with different thread ID access paths (i.e., the fifth inferring rule of Table 2) is inputted, the work will be dispatched to the vector engine, and the result with vector type is written back to the vector RF 305.

In FIG. 8, if a vector instruction for adding the values of one affine operand/register and a vector operand/register (i.e. the sixth inferring rule of Table 2) is inputted, the values of the affine and vector operands/registers are issued to the vector RF 305 for access, the converter 308 converts the value of the affine operand/register into vector representation, and then the vector ALUs 3090-3097 are allocated to perform add operation to produce a result with vector type. Afterwards, the result with vector type is written back to the vector RF 305.

Note that the values of the affine operand/register cannot be directly broadcasted to the vector ALUs 3090-3097 due to different data access paths. The base and stride values of the affine operand are stored in a base register and a stride register, and all the thread identifiers of the affine operand take the same data path to access the base and stride values for instruction execution. While the values of the vector operand are stored in parallel in vector registers, each of the thread identifiers of the vector operand takes different data path to access the values for instruction execution.

Therefore, the operand with affine representation should be translated to vector representation that performs a madd-like operation (similar to multiply-accumulate operation) “base+stride*warp_thread_id”. For software conversion, the madd-like operation can be inserted in the compiler 311; for hardware detection, the madd-like operation can be inserted by issuer 304 and performed by the converter 308. Take the affine vector V_{A1}=8+i*1 shown in FIG. 2 for example, the converter 308 performs the madd-like operation to output the integer values “8” to “15” to the vector ALUs 3090-3097, respectively.

For another case, Table 5 describes a program containing an affine instruction and a uniform instruction.

TABLE 5

S51: If ( threadID < cosntA)
S52: {
S53: A = threadID + 8;
S54: } else {
S55: A = cosntA + 32;
S56: }

Statement S53 is the affine instruction (in which the operand “threadID” with affine type makes Statement S53 to be affine type, the value of the base is determined during computation, and the stride is integer “1”) and statement S55 is the uniform instruction, but the result A is not uniform or affine type when the operand “threadID” declared in statement S51 in a warp takes different access paths. Therefore, in this situation, the scalar/affine ALUs 310 still performs the add operation, but the result A will be written back to the vector RF 305 according to the thread divergence state stored in the SIMT stack 300. Of course, the result A should be converted into generic vector representation before written back to the vector RF 305.

In FIG. 9, if a vector instruction for adding the values of two vector operands/registers (i.e. the seventh inferring rule of Table 2) is inputted, the values of the vector operands are issued to the vector RF 305 for access, and then the vector ALUs 3090-3097 are allocated to perform add operation to produce a result with vector type. Afterwards, the result with vector type is written back to the vector RF 305.

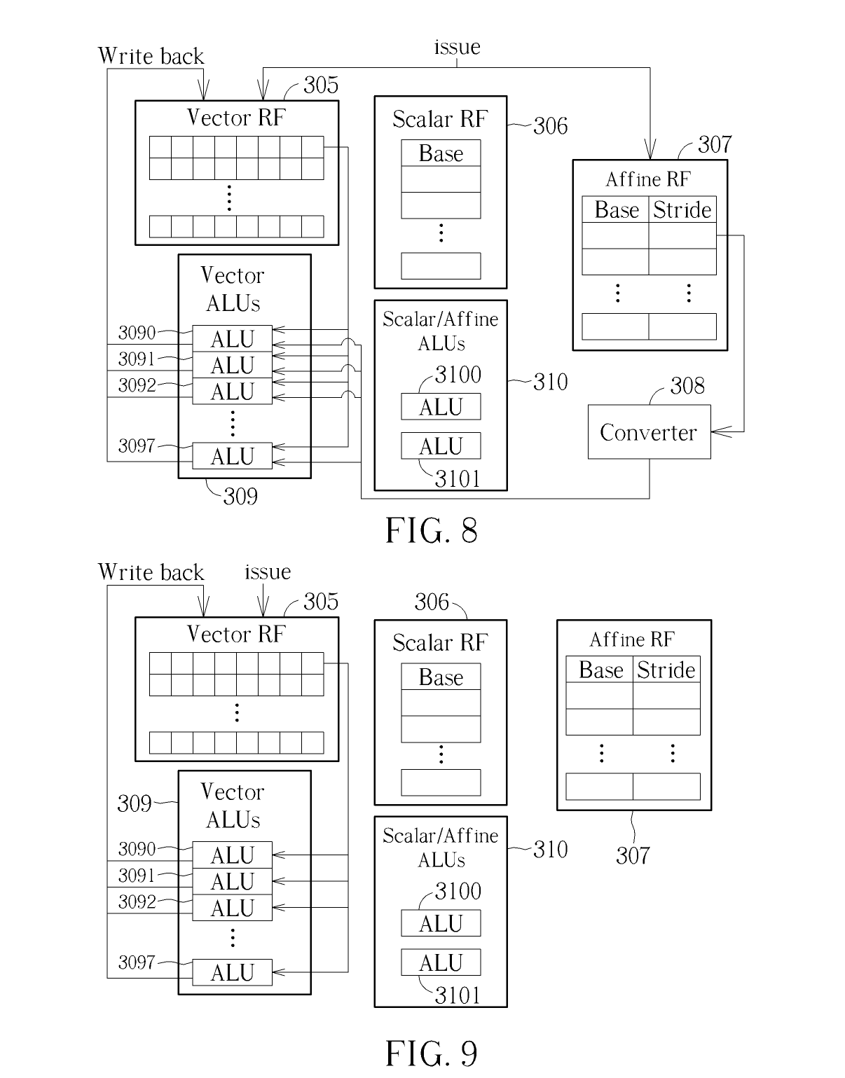

FIG. 10 is a flowchart of a process 100 according to an embodiment of the present invention. The process 100 can be compiled into a program code to be saved in a memory device of the GPU 30 and performed by the GPU 30. The process 100 includes the following steps.

Step 1000: Start.

Step 1001: Analyze a program to build a program dependence graph (PDG) to detect types of a plurality of source operands and an operator declared in an instruction of an instruction stack of the PDG and a type of the instruction, to encode a target machine code.

Step 1002: Decode the target machine code to annotate tags for indicating the type of each of the plurality of source operands, the operator and the instruction.

Step 1003: Issue values of the plurality of source operands to at least one of a scalar register file (RF), an affine RF, and a vector RF according to the tags for indicating the type of the plurality of source operands.

Step 1004: Determine whether to convert at least one of the values of the plurality of source operands from affine representation to vector representation according to the tags for indicating the type of the plurality of source operands, the operator and the instruction. Go to Step 1005 if no; go to Step 1007 if yes.

Step 1005: Allocate at least one scalar ALU or a plurality of vector ALUs for the instruction according to the tags for indicating the type of the plurality of source operands and the operator.

Step 1006: Use at least one scalar ALU or a plurality of vector ALUs to perform instruction execution with respect to the operator and the values of the plurality of source operands, to produce a result with the same type as the instruction. Go to Step 1008.

Step 1007: Convert the value of at least one of the plurality of source operands with affine representation to vector representation according to the tag for indicating the type of the operator and the type of the instruction. Return to Step 1005.

Step 1008: Write the result in one of the scalar RF, the affine RF, and the vector RF according to the type of the instruction.

Step 1009: End.

In the process 100, in the case of software detection, Steps 1001 and 1004 are realized by the compiler 311; in the case of hardware detection, type detection of Step 1001 is realized by the fetch and decide unit 301, and Step 1004 is realized by the issuer 304. Step 1002 is realized by the fetch and decide unit 301 and the tag unit 303; Step 1003 is realized by the issuer 304, the vector RF 305, the scalar RF 306 and the affine RF 307; Step 1005 is realized by the vector ALUs 309 and the scalar/affine ALUs 310; Step 1006 is realized by the vector RF 305, the scalar RF 306 and the affine RF 307; and Step 1007 is realized by the converter 308. Detailed operations regarding the process 100 can be obtained by referring to descriptions of FIG. 3 to FIG. 9, which is omitted.

To sum up, the present invention utilizes an affine engine to manage affine and uniform instructions. Source operands, operator, and instruction type detection can achieve either by software or hardware to add annotations or tags on each instruction, source operands and the operator, and then physical scalar/affine/vector registers and corresponding ALUs are allocated with maximum performance improving and energy saving. In runtime, the affine and uniform instructions are executed by the affine engine including an affine RF and two scalar ALUs in one SIMT core, and the general vector instructions are executed by the vector engine including a vector RF and a plurality of vector ALUs in one SIMT core. Therefore, the affine and uniform instruction execution can be dispatched to the affine engine, so the vector engine can enter a power-saving state to save the energy consumption of the GPU.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling instruction execution of a program for a graphic processing unit, comprising:
detecting types of a plurality of source operands and an operator declared in the instruction, to determine a type of the instruction;
annotating tags for indicating the type of each of the plurality of source operands, the operator and the instruction;
issuing values of the plurality of source operands to at least one of a scalar register file, an affine register file, and a vector register file according to the tags for indicating the type of the plurality of source operands;
allocating at least one scalar arithmetic logic unit (ALU) or a plurality of vector ALUs for the instruction according to the tags for indicating the type of the plurality of source operands, the operator and the instruction; and
using the at least one scalar ALU or the plurality of vector ALUs to perform instruction execution with respect to the operator and the values of the plurality of source operands, to produce a result with the same type as the instruction.

2. The method of claim 1, further comprising:
determining whether to convert the values of at least one of the plurality of source operands from affine or uniform representation to vector representation according to the tags for indicating the type of the plurality of source operands, the operator and the instruction.

3. The method of claim 2, wherein the values of at least one of the plurality of source operands are converted from affine or uniform representation to vector representation if the plurality of source operands comprises a general vector operand or the instruction is a general vector instruction.

4. The method of claim 3, wherein the value of at least one of the plurality of source operands are converted from affine representation to vector representation by performing an operation “base+stride*warp_thread_id”, where “base” and “stride” are the values of at least one of the plurality of source operands, and “warp_thread_id” corresponds to a plurality of thread identifiers of the instruction.

5. The method of claim 3, wherein the values of at least one of the plurality of source operands are converted from uniform representation to vector representation by broadcasting the values of at least one of the plurality of source operands to the plurality of vector ALUs.

6. The method of claim 1, wherein the at least one scalar ALU comprises a base scalar ALU and a stride scalar ALU.

7. The method of claim 6, wherein allocating at least one scalar ALU or the plurality of vector ALUs for the instruction comprises:
allocating the base scalar ALU for the instruction if the instruction is a uniform instruction or the plurality of source operands only comprises uniform operands; or
allocating the base scalar ALU and the stride scalar ALU for the instruction if the instruction is an affine instruction, or the plurality of source operands comprises a uniform operand and an affine operand, and the operator is an add operator; or
allocating the plurality of vector ALUs for the instruction if the instruction is a general vector instruction.

8. The method of claim 6, wherein using the at least one scalar ALU or the plurality of vector ALUs to perform the instruction execution with respect to the operator and the values of the plurality of source operands, to produce the result with the same type as the instruction comprises:
using the base scalar ALU to perform the instruction execution with respect to the operator and the values of the plurality of source operands, to produce the result with uniform type; or
using the base scalar ALU and the stride scalar ALU to perform the instruction execution with respect to the operator and the values of the plurality of source operands, to produce the result with affine type; or
using the plurality of vector ALUs to perform the instruction execution with respect to the operator and the values of the plurality of source operands, to produce the result with vector type.

9. The method of claim 6, wherein the base scalar ALU and the stride scalar ALU are used to produce the result with affine type if the plurality of source operands shares a same thread identifier access path.

10. The method of claim 6, wherein if the plurality of source operands comprises the uniform operand and the affine operand and the operator is the add operator, a zero value is generated to the stride scalar ALU.

11. A computing system of handling instruction execution for a graphic processing unit, comprising:
a processing device for handling instruction execution using an fine register file; and
a memory device coupled to the processing device, for storing a program code instructing the processing device to perform a process, wherein the process comprises:
detecting types of a plurality of source operands and an operator declared in the instruction, to determine a type of the instruction;
annotating tags for indicating the type of each of the plurality of source operands, the operator and the instruction;
issuing values of the plurality of source operands to at least one of a scalar register file, an affine register file, and a vector register file of the computing system according to the tags for indicating the type of the plurality of source operands;
allocating at least one scalar arithmetic logic unit (ALU) or a plurality of vector ALUs of the computing system for the instruction according to the tags for indicating the type of the plurality of source operands, the operator and the instruction; and
using the at least one scalar ALU or the plurality of vector ALUs to perform instruction execution with respect to the operator and the values of the plurality of source operands, to produce a result with the same type as the instruction.

12. The computing system of claim 11, wherein the process further comprises:
determining whether to convert the values of at least one of the plurality of source operands from affine or uniform representation to vector representation according to the tags for indicating the type of the plurality of source operands, the operator and the instruction.

13. The computing system of claim 12, wherein the values of at least one of the plurality of source operands are converted from affine or uniform representation to vector representation if the plurality of source operands comprises a general vector operand or the instruction is a general vector instruction.

14. The computing system of claim 13, wherein the value of at least one of the plurality of source operands are converted from affine representation to vector representation by performing an operation “base+stride*warp_thread_id”, where “base” and “stride” are the values of at least one of the plurality of source operands, and “warp_thread_id” corresponds to a plurality of thread identifiers of the instruction.

15. The computing system of claim 13, wherein the values of at least one of the plurality of source operands are converted from uniform representation to vector representation by broadcasting the values of at least one of the plurality of source operands to the plurality of vector ALUs.

16. The computing system of claim 11, wherein the at least one scalar ALU comprises a base scalar ALU and a stride scalar ALU.

17. The computing system of claim 16, wherein allocating at least one scalar ALU or the plurality of vector ALUs for the instruction comprises:
allocating the base scalar ALU for the instruction if the instruction is a uniform instruction or the plurality of source operands only comprises uniform operands; or
allocating the base scalar ALU and the stride scalar ALU for the instruction if the instruction is an affine instruction, or the plurality of source operands comprises a uniform operand and an affine operand, and the operator is an add operator; or
allocating the plurality of vector ALUs for the instruction if the instruction is a general vector instruction.

18. The computing system of claim 16, wherein using the at least one scalar ALU or the plurality of vector ALUs to perform the instruction execution with respect to the operator and the values of the plurality of source operands, to produce the result with the same type as the instruction comprises:
using the base scalar ALU to perform the instruction execution with respect to the operator and the values of the plurality of source operands, to produce the result with uniform type; or
using the base scalar ALU and the stride scalar ALU to perform the instruction execution with respect to the operator and the values of the plurality of source operands, to produce the result with affine type; or
using the plurality of vector ALUs to perform the instruction execution with respect to the operator and the values of the plurality of source operands, to produce the result with vector type.

19. The computing system of claim 16, wherein the base scalar ALU and the stride scalar ALU are used to produce the result with affine type if the plurality of source operands shares a same thread identifier access path.

20. The computing system of claim 16, wherein if the plurality of source operands comprises the uniform operand and the affine operand and the operator is the add operator, a zero value is generated to the stride scalar ALU.
